(19) United States
(12) Patent Application Publication
(10) Pub. No.: US 2024/0268604 A1
(43) Pub. Date: Aug. 15, 2024

(54) Portable BBQ grill

(71) Applicant: Tibogrill Inc, Ottawa (CA)

(72) Inventors: Gerard Thibault, Kanata (CA); David Andrew McMullin, Ottawa (CA); William Dicke, Gatineau (CA)

(21) Appl. No.: 18/644,530

(22) Filed: Apr. 24, 2024

Related U.S. Application Data
(63) Continuation-in-part of application No. 17/998,044, filed on Nov. 7, 2022.
(60) Provisional application No. 63/026,838, filed on May 19, 2020.

(51) Int. Cl. A47J 37/07; A47J 37/10

(52) U.S. Cl. CPC A47J 37/0763; A47J 37/0786; A47J 2037/0795; A47J 37/10

(57) ABSTRACT

A BBQ Grill comprising two side assemblies each with a lower side panel, an upper side panel, each of the upper side panels being slideably received in respective lower side panels. Cross braces space the panels apart and a grill plate is adapted to detachably engage apertures in the upper side panels. The grill has legs that extend and retract associated with the lower side panels and the upper side panels have a handle assembly with a push button to set pawls of a latch plate at selected apertures associated with the lower side panel. The grill preferably includes a rear wall, a drip tray and fuel support configured with the grill plate to be assembled between the two side assemblies in cooperation with the cross braces selectively connecting the two lower side panels. Various accessories are disclosed. The grill can use wood, charcoal briquettes or gas.

### CROSS REFERENCE TO RELATED APPLICATIONS

In accordance with 37 C.F.R. § 1.76, a claim of priority is included in an Application Data Sheet filed concurrently herewith. The present application is a continuation-in-part application of U.S. patent application Ser. No. 17/998,044, filed May 18, 2021, which is a 35 U.S.C. § 371 U.S. National Phase Application of PCT/CA2021/000044, filed May 18, 2021, which claims the benefit of the priority of U.S. Provisional Patent Application No. 63/026,838 filed May 19, 2020, the contents of each are incorporated hereby by reference.

### FIELD OF THE INVENTION

The invention relates to a portable grill for barbequing and more particularly, a grill that may be assembled and disassembled easily to provide a compact grill for transportation.

### BACKGROUND OF THE INVENTION

Portable BBQs and rotisseries are well known. U.S. Pat. No. 3,059,568 to Fortis, Oct. 23, 1962 is foldable into a compact article when not in use. The article is designed for use without requiring an external source of electrical power and designed for use with battery power or a spring-driven motor.

U.S. Pat. No. 3,611,912 to Choc, Oct. 12, 1971, relates to a portable grill with a hinged carrying case openable to form an elongated planar grill base or counter top. Legs are swingable out of the case to support the base at an elevated horizontal position. Sidewall forming members fitting in the case are attachable to the top of the base to form support for hot coal holding racks and permitting grilling or rotisserie operation.

U.S. Pat. No. 5,333,540 to Mazzocchi, Aug. 2, 1994, relates to a portable barbeque adapted to be moved between a closed/folded configuration and an open/assembled configuration and reversed.

U.S. Pat. No. 5,367,950 to Sarich, Nov. 29, 1994, also relates to a portable vertical heat source rotisserie and includes a pair of removable spit carriers and a pair of removable covers which are configured to provide the function of covering and enclosing the unit and of opening up to serve as drip pans and ash catches.

More recently there is U.S. Pat. No. 6,546,845 to Lanzilli, Apr. 15, 2003, related to a collapsible rotisserie and grill and oven combination. There are folding side panels and a folding rear panel with a front panel for engagement with the side panels.

U.S. Pat. No. 7,856,924 B1 to Stihi, Dec. 28, 2010, relates to a collapsible barbeque with variable firebed positions.

German Patent DE 10 2017 106 276 A1 to Ledderer, Sep. 27, 2018, relates to a transporatable grill with a charcoal box and a grill slideably mounted between positions, up and lower positions, and hinged legs.

Notwithstanding the numerous portable grills, a further collapsible grill that is sturdy and compact when packaged is desired.

### SUMMARY OF THE INVENTION

The invention in one broad aspect pertains to a portable BBQ grill assembly comprising two mirror imaged side panel assemblies, the side panel assemblies each comprising a lower side panel and an upper side panel. Each lower side panel has at least one outwardly directed flange at the base of the lower side panel. Two cross braces are configured in operative position to connect with sides of the lower side panels and space the lower side panels apart. Each upper side panel is configured to slideably connect with one of the lower side panels. A grill plate is configured to detachably connect with the slideable upper side panels. When the grill is in a packaged condition, the side panel assemblies house at least the grill plate between them and the cross braces slideably connect with the at least one outwardly directed flanges of the lower side panels.

The invention further provides for a rear wall and a drip tray, the rear wall configured to detachably connect between sides of the lower side panels and the drip tray configured to detachably connect with the spaced lower side panels below the cross braces. The rear wall and drip tray are also configured to be located with the grill plate between the lower side panels when the grill assembly is in the packaged condition.

The invention also contemplates a grill assembly further comprising a fuel support configured to be suspended from the cross braces when the grill is in the operative position and also configured to nest within the drip tray when the grill assembly is in the packaged condition. Still further, the invention provides a grill assembly wherein the grill plate has corners, with each corner having projections perpendicular to a plane of the grill plate. One of the projections is a downwardly directed projection adapted for connection with a circular aperture of the lower side panel. There is also an upwardly directed projection in axial alignment with the downwardly directed projection for connection with the upper side panel assembly. Stepped projections are adjacent the upwardly directed projection. Each corner of the rear wall and each corner of the drip tray has an aperture for connection with one of the steps of the stepped projections.

The grill assembly may further include feet structures, including feet slidably connected with the lower portion of the outer side panel, the structure and feet are adapted to slide downwardly and outwardly from a retracted position to an extended position. The feet structure comprises a bracket wherein, in the extended position, the bracket prevents the cross braces from being removed from the outer side panels.

### BRIEF DESCRIPTION OF THE DRAWINGS

FIG. 1 is a perspective view of the portable BBQ grill assembly with the grill plate in an upper position;

FIG. 2 is a perspective view of the portable BBQ grill assembly of FIG. 1, with the grill plate in a lower position;

FIG. 3 is a top view of the portable BBQ grill assembly of FIG. 2;

FIG. 4 is a perspective view of the outward facing side of the lower side panel;

FIG. 5 is a perspective view of the inward facing side of the upper side panel;

FIG. 6 is a top view of the upper side panel of FIG. 5, nested within the lower side panel of FIG. 4;

FIGS. 7a and 7b are perspective views of the outward facing side and inward facing side of a foot that attaches on the side of the outer side panel, and FIG. 7c is similar to FIG. 7a from the other end of the foot. It will be appreciated that the foot on one side of the outer side panel is the mirror image of the other foot;

FIG. 8a and FIG. 8b are perspective views of a flat spring clip that is associated with each foot that attaches to the inside surface of the outer side panel;

FIG. 9a illustrates the assembly of the right foot of FIG. 7a to the inside of the outer side panel of FIG. 5 and FIG. 9b illustrates the assembly of the left foot to the inside of the same panel;

FIGS. 9c and 9d illustrate inside view and top view the fastened foot of FIG. 9b to the lower side of the outer panel;

FIG. 9e is an enlarged cross sectional view of a portion of the right side of the lower panel with an attached foot of FIG. 9d with the flat spring clip of FIG. 8 secured by rivets;

FIG. 10a is a perspective view of the outward facing side of the handle which is also shown in FIG. 2 as part of the BBQ grill assembly;

FIG. 10b is a perspective view of the inward facing side of the handle of FIG. 10a;

FIG. 11 is an exploded perspective view of the assembly of a latch plate and a cover plate with projections (not seen) and securement washers;

FIG. 12a is an exploded perspective view of the assembly of the latch plate and cover plate of FIG. 11 with the inward facing side of the handle;

FIG. 12b is a perspective view of the assembled latch plate and handle assembly of FIG. 12a;

FIG. 13a is an exploded perspective view of the assembly of the latch plate and handle assembly of FIG. 12b with the upper inside panel of FIG. 5;

FIGS. 13b and 13c illustrate the inward facing side and the outward facing side, respectively, of the assembled upper panel with handle of FIG. 12b;

FIGS. 14a and 14b are perspective views of the outward facing side and the inward facing side, respectively, of a cross brace which is shown as part of the portable BBQ grill assembly of FIG. 1;

FIGS. 15a and 15b, respectively, are perspective views of the panel assembly of upper inner side panel and outer side panel and cross braces, FIG. 15a illustrates one cross brace and feet retracted, and 15b illustrates both feet extended and two cross braces connected to the inside and outside panel assemblies;

FIG. 16a and FIG. 16b are perspective views of the back and front of a rear wall;

FIGS. 16c, 16d and 16e are perspective views illustrating the assembly of the rear wall to the outer side panels;

FIGS. 17a, 17b and 17c, are top perspective views of a grill plate, with FIGS. 17b and 17c illustrating its assembly of the grill plate in relation to the inner side panel of the grill assembly. FIGS. 17d and 17e are perspective views of a corner of the grill plate with projections configured for aligning disassembled parts for packing, FIG. 17d being an enlarged view of the corner from below and FIG. 17e along with a skewer of the corner from above;

FIGS. 18a to 18d are perspective views of a skewer button, FIG. 18a the inside, and FIG. 18b the outside of the button. FIGS. 18c and 18d illustrate the construction of the skewer button from an outside view and inside view, respectively;

FIGS. 19a and 19b are perspective views of a skewer;

FIG. 20 illustrates the assembly of an end of a skewer and a button, the button shown in a sectional view;

FIGS. 21a and 21b are upper and lower perspective views of a skewer tine;

FIG. 22 illustrates the skewer, skewer tine and button in place on the grill;

FIGS. 23a and 23b illustrate the upper side and lower side of a drip tray;

FIGS. 23c to 23e are perspective views illustrating the drip tray being installed into the grill with FIG. 23e showing the drip tray from underneath the grill;

FIGS. 24a to 24d are perspective views of a fuel support, respectively, as constructed (FIG. 24a), open (FIG. 24b) and being lowered into place to connect with the cross braces (FIG. 24c), and FIG. 24d illustrating the fuel support closed;

FIG. 25 illustrates the various parts of the grill assembly previously set forth being assembled and in position for packaging;

FIGS. 26a and 26b illustrate the assembly of the cross braces to the assembled parts of the grill assembly to secure the parts together, with the rails of the braces slidingly connecting with the flanges on the lower ends of the outer side panels;

FIG. 27a is a top view of the grill as packaged with FIG. 27b being a cross sectional view along line A-A and FIG. 27c an enlarged view of part circled of FIG. 27b;

FIGS. 28a to 28d illustrates the construction of a grill basket. FIGS. 28a, and 28b, illustrate the parts of the basket base, sides and ends. FIGS. 28c and 28d illustrate exploded views of the corner connections between sides and ends. FIG. 28e illustrates the basket with the skewer assembled and FIG. 28f illustrates a cover for the basket shown in 28b. FIG. 28g illustrates the basket with cover assembled on the skewer assembly for the grill;

FIGS. 28h to 27j illustrate the basket and the cover being assembled and folded for storage;

FIGS. 29a to 29b illustrate a burner assembly kit for use with the BBQ grill;

FIGS. 30a and 30b illustrate a frying pan;

FIGS. 30c to 30e illustrate in various perspective views and partial perspective views of a rod connectable to the grill and the frying pan providing a rain shield to the grilling plate;

FIGS. 31a to 31d illustrate various views or partial views of a telescopic light that is connectable to the grill assembly;

FIGS. 32a and 32b illustrate a cutting board that may be used as part of the BBQ kit;

FIGS. 33a and 33b are a top perspective view and a bottom perspective view of a modified cutting board;

FIG. 34 is an exploded view of the assembly of the accessory kit or package;

FIG. 35a is an exploded perspective view of the accessory kit being associated on top of the packaged grill;

FIG. 35b is a perspective view of the accessory kit and grill assembly together; and

FIG. 36 is a top perspective view of the grill without the accessory kit in a carrying case.

### DESCRIPTION OF PREFERRED EMBODIMENTS

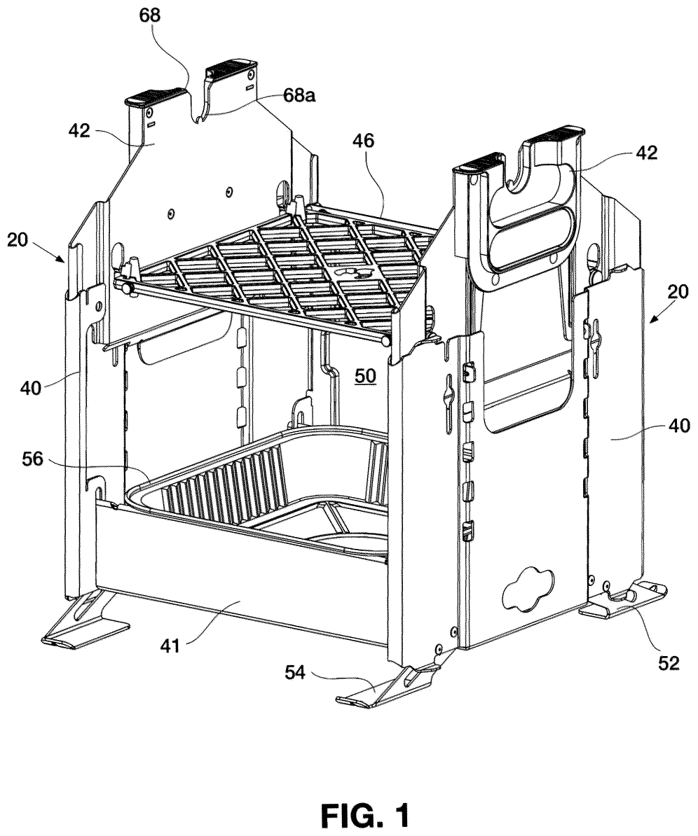

Various parts and accessories described in the foregoing disclosure are described relative to their orientation, position and/or installation with respect to the assembled portable BBQ grill depicted in FIG. 1. For example, various parts and accessories are described herein as having surfaces that face inwards, outwards, upwards, and/or downwards, for which directions and/or orientations are taken in the context as to whether they face towards the inside or outside of the portable BBQ grill assembly, or whether they face upwards or downwards relative to what is understood to be the upright position of the portable BBQ grill assembly shown in FIG. 1.

The portable BBQ grill assembly (or referred to simply as the grill) disclosed herein is a small but versatile grilling system that can be quickly assembled to cook food safely and efficiently over a combustible fuel heat source and then, once cooled, easily dissembled for compact storage. While the compact design and modularity of the grill minimizes its size, particularly when disassembled, which lends to its portability, the assembled grill and the additional features not only simplify cooking, but enhance a user's cooking experience by providing a variety of cooking methods (such as straight grilling, basket grilling, rotisserie) in one versatile and convenient system.

The portable BBQ grill assembly includes two sidewall assemblies and a rear wall that, together, form a three-sided enclosure around a heat source that will cook food overtop. The two sidewall assemblies and the rear wall are secured together at the bottom end of the grill by two cross braces. In the case of a solid fuel heat source, of which may include charcoal, charcoal briquettes, wood, pellets, or some other solid fuel suitable for cooking food, the solid fuel may be placed in a combustion tray at the bottom of the grill assembly which is supported by the two cross braces, the sidewall assemblies, or both. In the case of a gas heat source, a burner assembly can be inserted through one of the sidewall assemblies, with the gas source located external of the grill.

The food to be cooked over the heat source can be supported by a variety of different means including a wire grill or a cast metal grill plate, in a cooking basket, or on a rotisserie (or spit). Providing a variety of cooking methods increases the variety of the type of foods that can be cooked, and can simplify cooking and meal preparation. An example of this would be cooking a whole chicken on the rotisserie as opposed to having to prepare and cook all the different components of a whole chicken, or cooking a whole fish or other delicate foods in the grill basket so the food is less likely to fall apart and into the heat source.

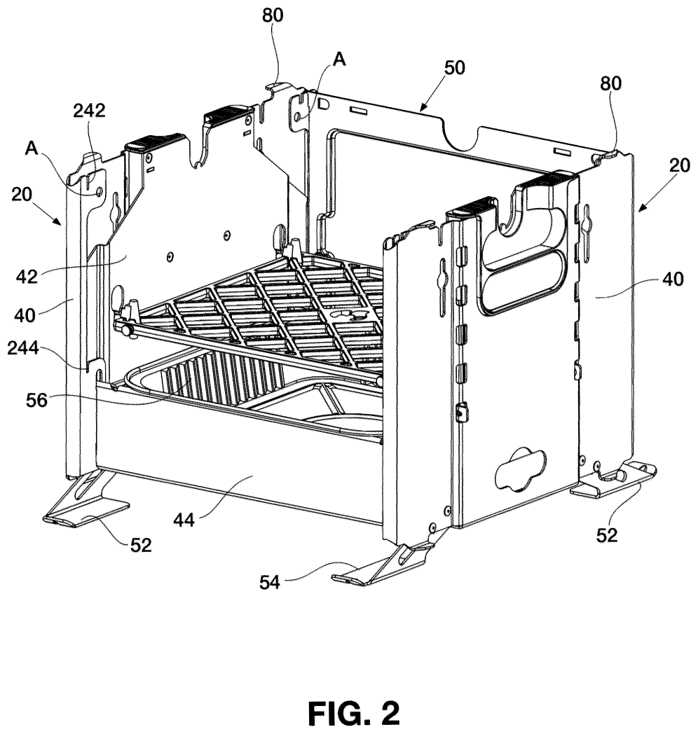

FIG. 1 illustrates the basic portable BBQ grill assembly which includes two opposed sidewall assemblies 20, two opposed cross braces 44 (only one visible), a grilling surface or plate 46, and a rear wall 50. FIG. 2 illustrates the portable BBQ grill shown in FIG. 1, but with each sidewall assembly 20 in a lower position, as compared to FIG. 1 which illustrates the portable BBQ grill with the side wall assemblies 20 in a raised position. As can be seen in FIG. 1, each of the BBQ grill sidewall assemblies 20 comprise an outer or lower side panel 40 and an inner or upper side panel 42 that is nested therewithin. The height-adjustable upper side panels 42 provide more control over the cooking temperature directed at the food on the grill plate 46 as the height of the panels 42 can be adjusted according to the doneness of the food and/or the intensity of heat.

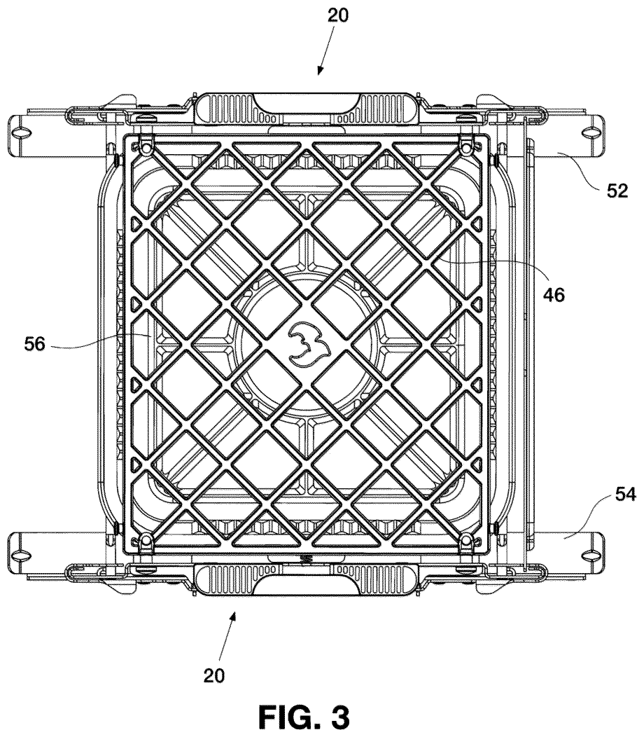

FIG. 3 illustrates the portable BBQ grill from the top.

FIG. 3 also illustrates right feet 52 and left feet 54 in an extended position, whereas FIGS. 1 and 2 illustrate foot 52 retracted and foot 54 extended. It should be noted that the right feet 52 are mirror images of the left feet 54 and, in this case, the notation ‘right’ and ‘left’ is relative to a view of the outward facing side of each lower side panel 40 to which the feet are attached (i.e. the lower side panel 40 on the left side of the portable BBQ grill has both right and left feet). FIGS. 1 to 3 also illustrate a tray 56 to hold and contain the solid combustible fuel, which may be wood, charcoal or briquettes, and the tray 56 may be packaged with the grill or carried separately, or in a case for the BBQ grill. FIGS. 1 to 3 are essentially the same as in the related applications noted above, subject to noted variations herein.

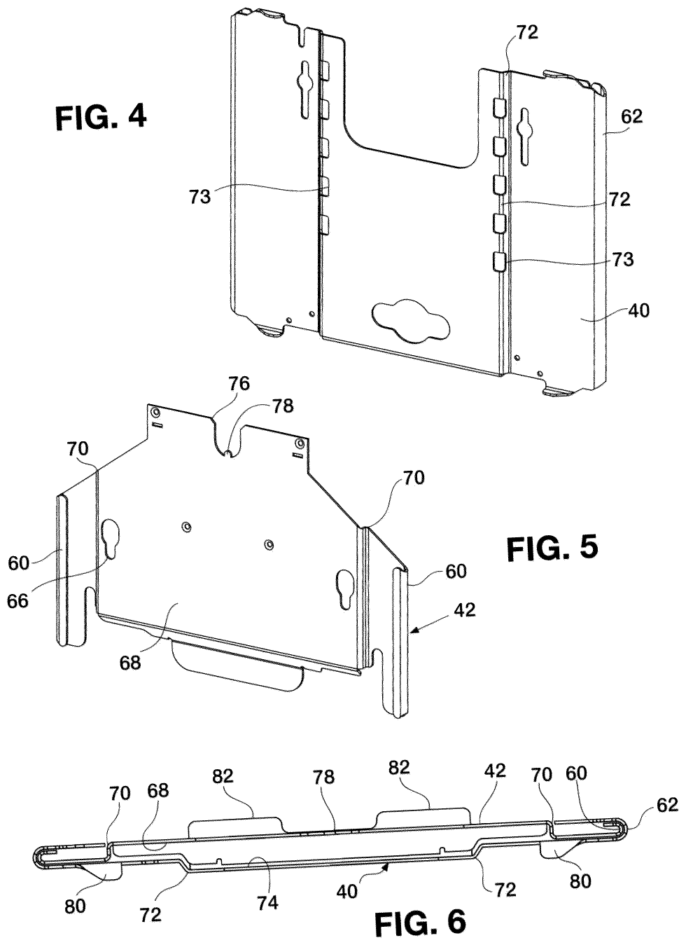

FIGS. 4 and 5 illustrate the lower side panel 40 and the upper side panel 42, respectively. FIG. 6 illustrates a top view of the interconnection of the two panels in which the upper side panel 42 is nested within the lower side panel 40. The upper side panel 42 has vertical edges 60 that are outwardly curved and which fit within the vertical edges 62 of the lower side panel 40 that are inwardly curved. The upper side panel 42 also has grill plate support apertures 66 that suspend the grill plate over a heat source. These apertures 66 are shaped to accept grill plate protrusions through the upper aperture section and to settle into the lower aperture section. The engagement between the grill plate support apertures 66 and the grill plate 46 improves the lateral and transverse stability of the grill assembly. Each lower side panel 40 also has U-shaped notches 67 and projection 67a at its bottom.

It will be seen from FIGS. 5 and 6 that the upper side panel 42 has a vertical channel 68 formed therein with a base that is offset inwards, towards the inside of the grill, and that is further defined by two vertical bend sections 70. FIGS. 4 and 6 show a vertical channel 74 formed in the lower side panel 40, but with a base that is offset outwards, opposite the vertical channel 68 formed in the upper side panel 42, and that is further defined by two vertical bend sections 72 with latch lock apertures 73. The vertical channels 68 and 74 not only increase the rigidity of each side panel to improve the overall stability of the BBQ grill assembly, the enlarged space formed between the two opposing channels 68 and 74, as seen in FIG. 6, acts to guide and support the height adjustment mechanism when raising and lowering the portable BBQ grill. The upper section of the upper side panel 42 has a semi-circular notch 76 with inner projection 78 to accommodate additional features of the grill assembly to be noted herein. FIGS. 4 and 6 illustrate flanges 80 extending outwardly of lower side panel 40 and flanges 82 not seen in FIG. 4, extending inwardly of the lower side panel 40.

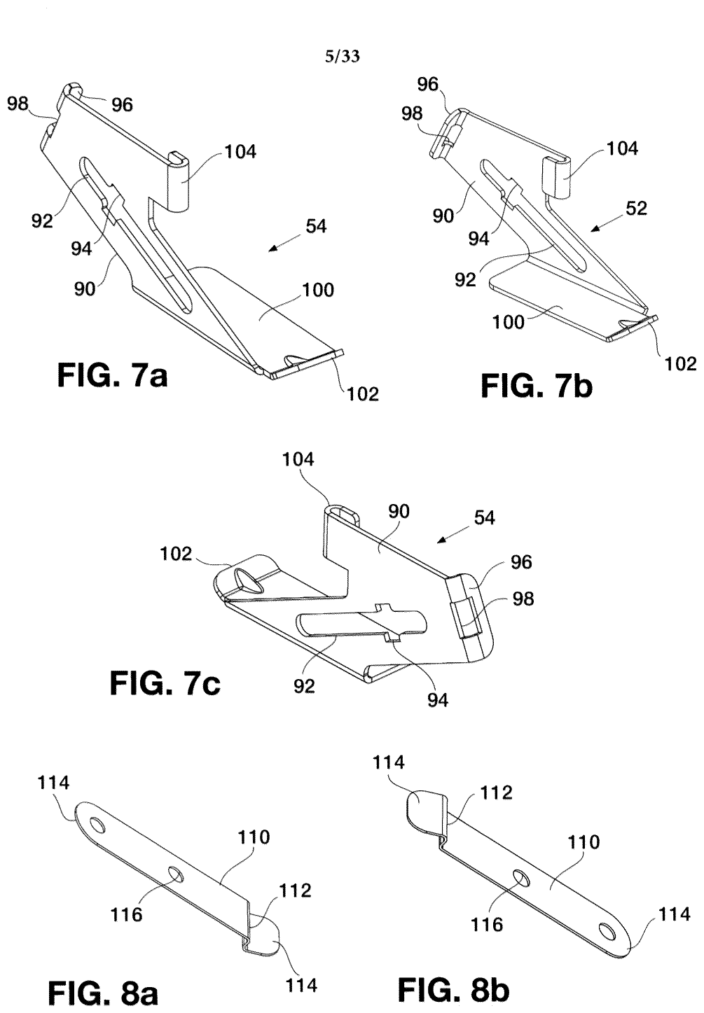

FIGS. 7a and 7b illustrate left and right feet 54, 52, and the left foot 54 being a mirror image of right foot 52. Each of the feet 52, 54 has a slanted leg 90 with a longitudinal aperture 92 with a notch 94 intermediate the rounded ends of the aperture 92. The upper end 96 of the leg 90 has a semi-circular portion bent back on itself and to form a guide aperture 98. Extending from a side of the leg 90 is a horizontal foot 100 with slanted foot end 102 extending from one end. The foot end 102 is slightly raised such that the foot end resembles a skid which can facilitate and aid in the extension of the foot and in repositioning the assembled BBQ grill on uneven an uneven surface or ground. At the end of the foot opposite guide aperture 98 is inwardly curved portion 104. FIG. 7c is similar to FIG. 7b from the other side of the foot.

FIGS. 8a and 8b illustrate a flat spring clip 110 with a V-shaped projection 112 and ends 104, 114. Fastening holes 116 are shown.

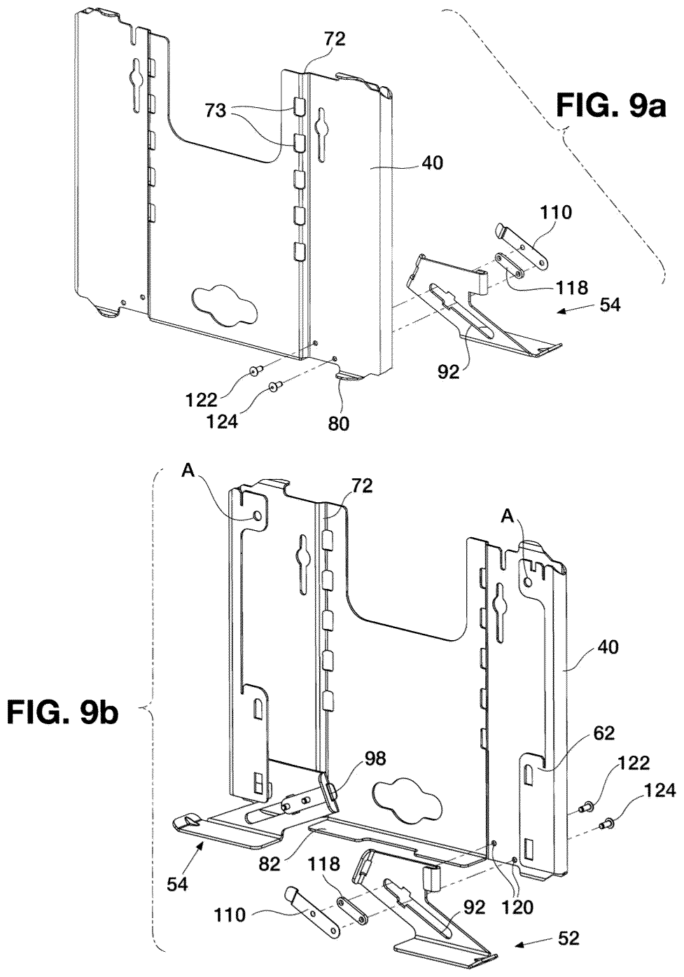

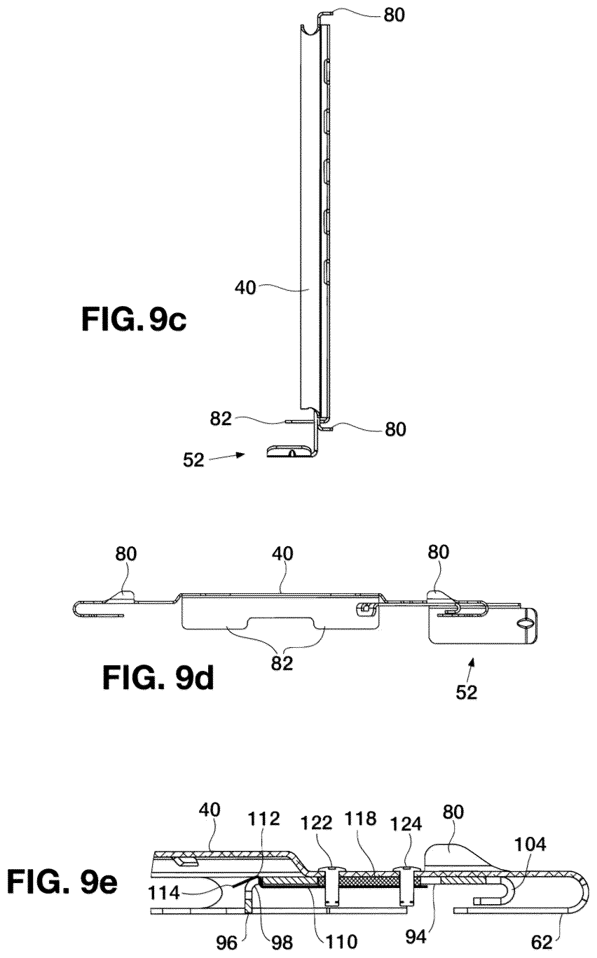

FIG. 9a to FIG. 9e illustrate the connection of foot 54 (and foot 52) to the lower side panel 40 facing outwardly in FIG. 9a and inwardly in FIG. 9b. The outer panel 40 has holes 120 (for fastener means) and foot 54 has slide elements 118 to slide in slot 92 with foot 54 to securely guide the foot 54 when it moves from a retracted position to an extended position. Foot 54 is in the extended position in FIG. 9b with the end V-shaped projection 112 located in the aperture 98. In the retracted position, V-shaped projection 112 is retained on notch 94 (not shown).

FIGS. 9c and 9d illustrate the foot structures in relation to lower side panel 40 in side view and top view.

The flat spring clip 110 and slider 118 are secured to the inside surface of the lower side panel 40 by suitable fastening means, such as rivets 122, 124. The end of the flat spring clip with the V-shaped projection 112 extends such as to reside in notch 94 when the foot 52 is in retracted position and in the aperture 98 when in the extended position.

FIG. 9e illustrates the fastening of the foot 52, and the assembly of the flat spring clip 110, including slider 118 and rivets 122, 124. The V-shaped projection 112 of the flat spring clip 110 engages with the aperture 98 in the leg 90 of each foot 52, 54 to assist in retaining and securing each foot in an extended position. The flat spring clip 110 and the apertures 98 and the notches 94 in the leg 90 of each foot 52, 54 are configured such that the spring force of the spring clip 110 may be overcome by simply pulling the tip inwards, to release V-shaped projection of each foot from either notch or aperture.

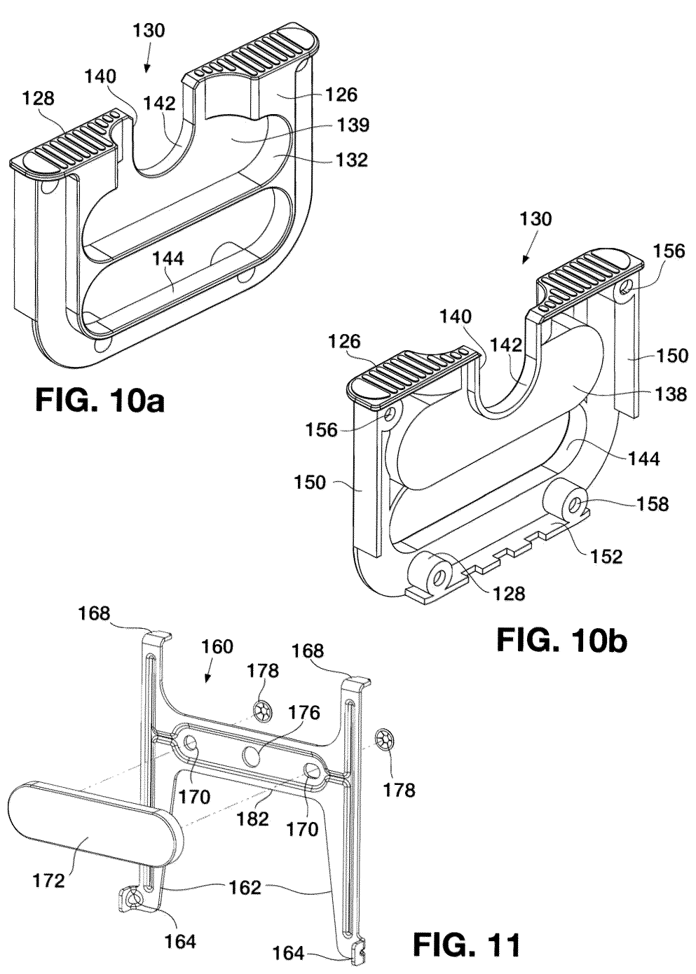

FIGS. 10a, 10b, illustrate respectively, the outer side 126 and inner side 128 of the U-shaped handle 130. The outer side 126 has an oblong recess 132 with backing 138 and a U-shaped recess 140 with flange 142, an oblong opening 144 is under recess 132. The inner side 128 has side flanges 150 and bottom flange 152. The inner side flanges 150 have apertured bosses 156 and bottom flange 152 apertured bosses 158.

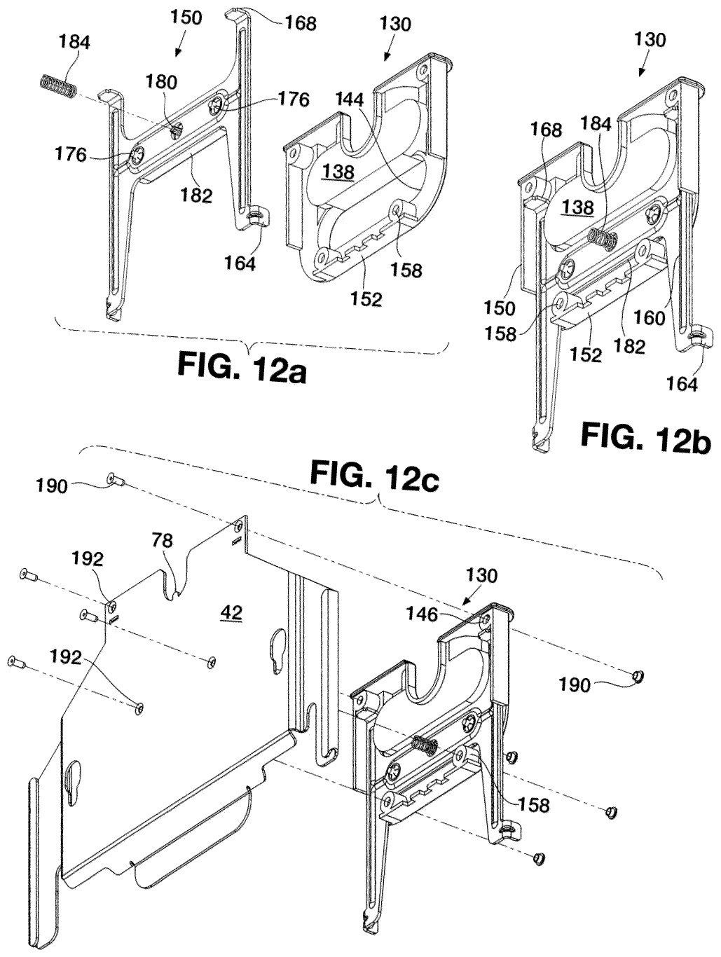

FIG. 11 shows latch plate 160 having latch plate legs 162, which are a mirror image of each other, with each leg 162 having a projection or pawl 164 at the end, configured and adapted to engage the channel latch locks 73 (FIGS. 4 and 9a) which are the apertures along the bend sections 72 of the lower side panel 40. The latch plate 160 also has upper leg flanges 168, as well as clip apertures 170. Oblong push button 172 has radially spaced projections 176 (seen in FIG. 12a) that align with the latch plate apertures 170 and are secured by press washers 178. Another aperture 176 on the latch plate 160 is a spring guide aperture and for a projection 180 part of push button 172 (see FIG. 12a).

FIGS. 12a and 12b illustrate the attachment of the latch plate 160 to the handle 130, whereby the bottom latch arc 182 is supported by flange 152 and bosses 158. A spring 184 is located on projection 180 and protrudes through spring guide aperture 176 and extends through the spring guide aperture 176. FIG. 12c illustrates the connection of the upper panel 42 to the embodiment of FIG. 12b with rivets 190 through appropriately configured and located holes 192 in upper side panel 42, and bosses 146 and 158 of the handle assembly.

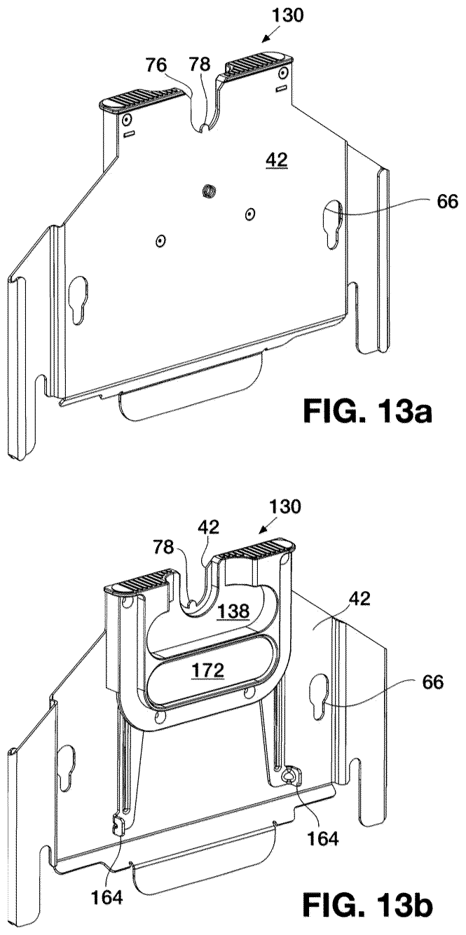

FIGS. 13a and 13b illustrate the completed upper panel assembly with the handles and latch plate 160, with views respectively from the inside FIG. 13a and outside FIG. 13b of the panel assembly.

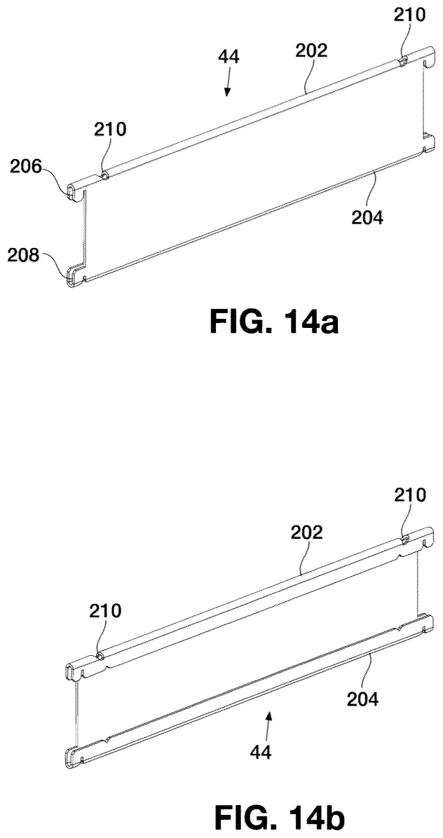

FIGS. 14a and 14b illustrate a cross brace 44 with the long edges folded over to form upper and lower longitudinal rails 202, 204. At the ends of each rail 202, 204, are upper and lower rail hooks 206, 208. Also shown on the upper rail 202 are notches 210.

FIGS. 15a and 15b illustrate the attachment of the cross brace 44 to lower panel 40, the rail hooks 206 and 208 inserted into respective rail lock slots 220, 222 in flanges 62 of flower panel 40 and forced downwardly. As shown in FIG. 15a, the feet 52 and 54 are in the retracted position when the braces 44 are assembled to the lower side panels.

As shown in FIG. 15b, feet 52 and 54 are extended. Part 104 of the feet overlies the lower hook 208 for greater security of the assembly and for stability. The other cross brace 44 is similarly attached to the other side of lower panel 40 as shown in FIG. 15b.

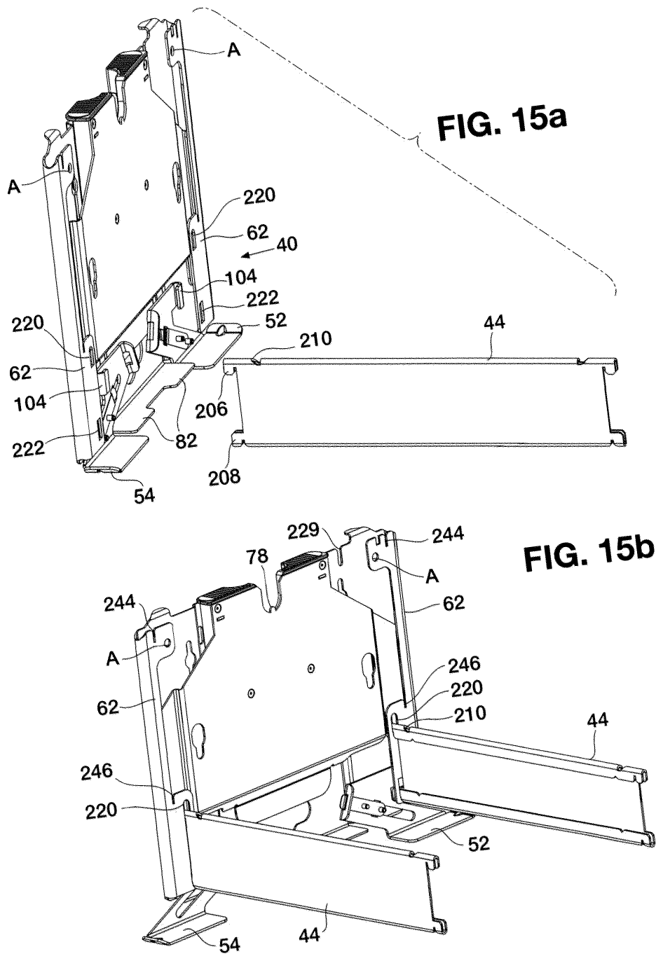

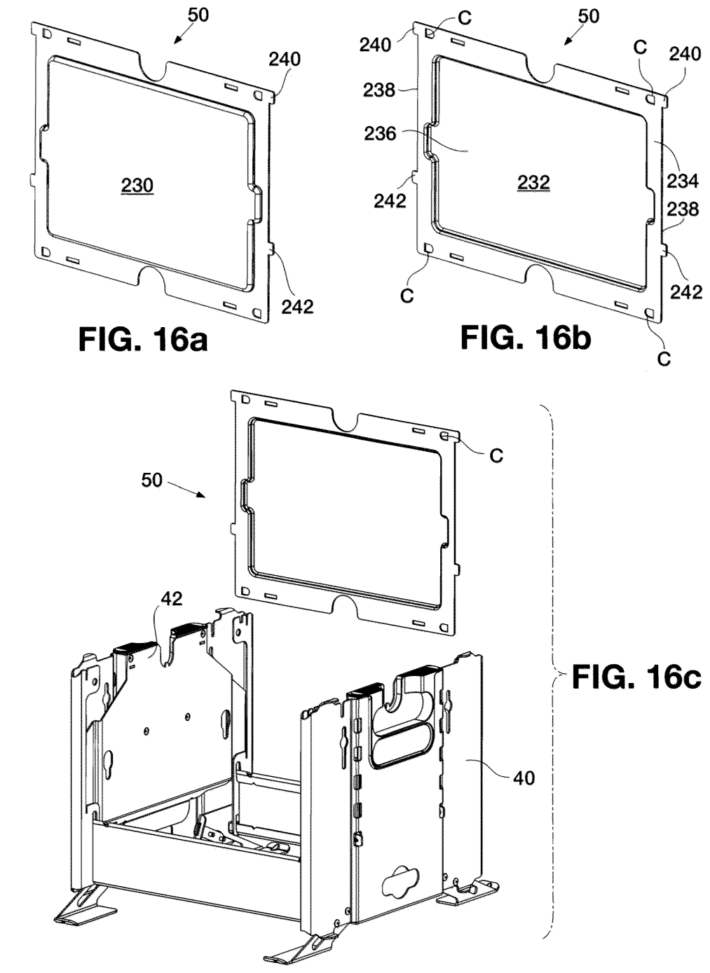

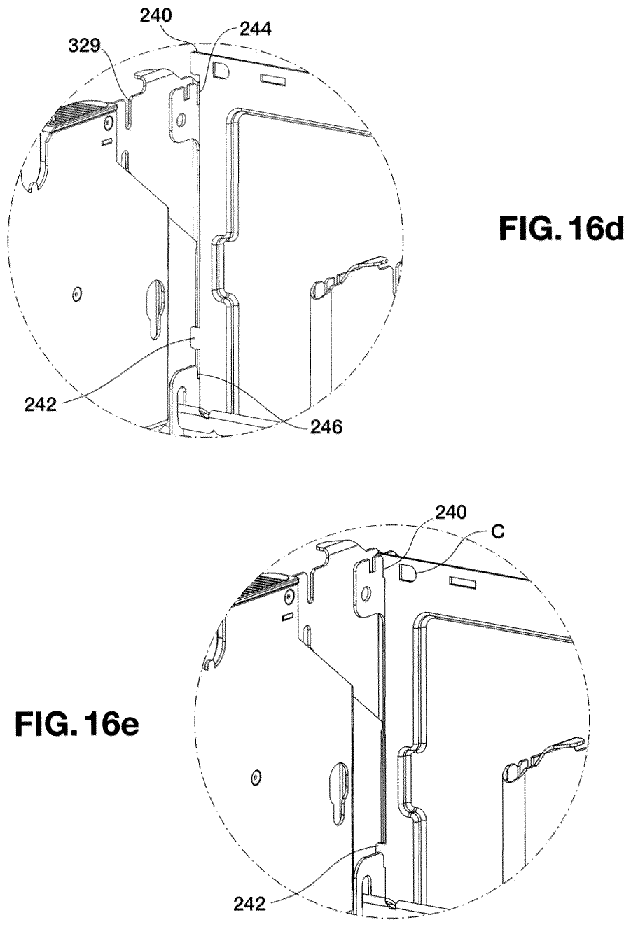

FIG. 16a and FIG. 16b illustrate the rear wall 50, with FIG. 16a illustrating the outer back face 230 and FIG. 16b illustrating the inside face 232 of the rear wall 50. The inside face 232 of the rear wall has sidewalls 234 and a depression 236. Side edges 238 of the wall 50 have outwardly extending flanges, upper flanges 240, and lower flanges 242. FIG. 16c illustrates wall 50 ready to be removably mounted to lower side panels 40. As illustrated in FIGS. 16d and 16e, upper flange 240 is aligned with upper slot 244 and lower flange 242 is aligned with lower slot 246. Slots 224 and 246 may also be seen in FIG. 15b and FIG. 2.

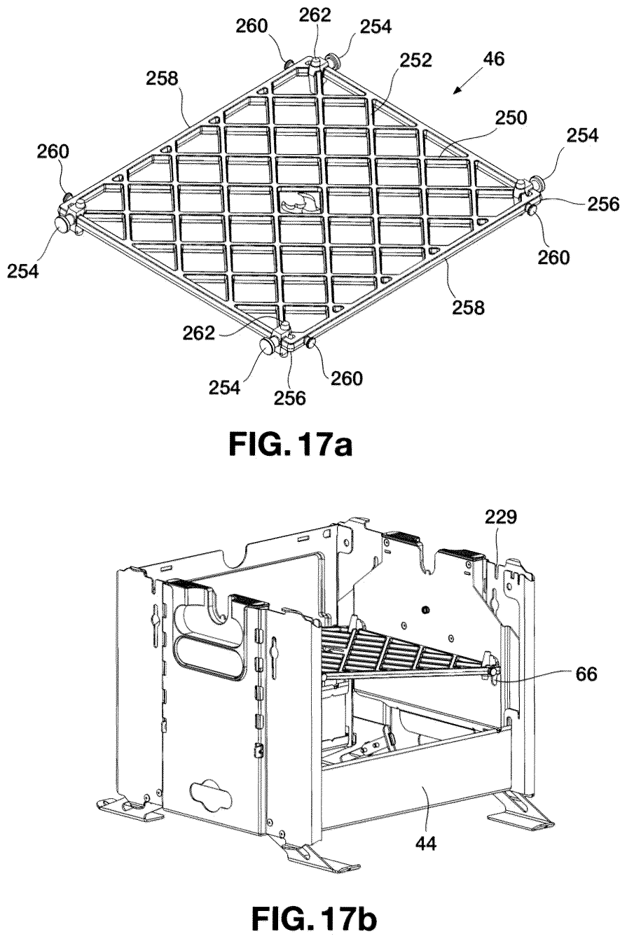

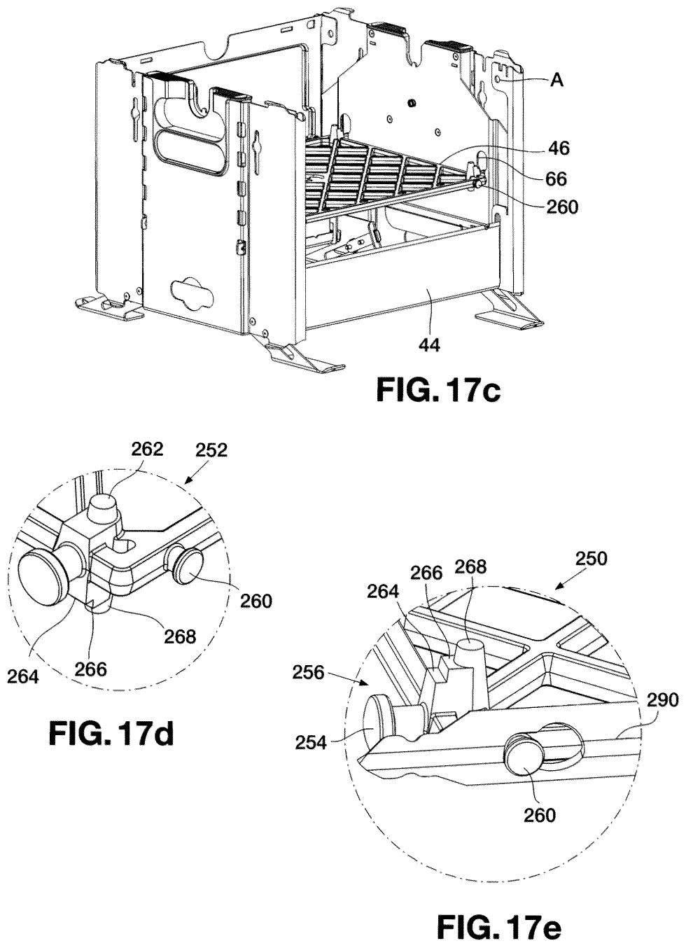

FIG. 17a illustrates the grill plate 46 with upper surface 250 and lower surface 252, as will become more evident herein. Knobs 254 extend from corners 256 on opposite sides of grill plate 46 and are configured to cooperate with the grill plate apertures 66 on the upper side panel 42 as illustrated in FIGS. 17b and 17c. The sides 258 also have smaller outward knobs 260 for holding a skewer 290 as set forth herein and illustrated partly in FIG. 17e. FIGS. 17d and 17e illustrate enlarged views of the corner 256 of the grill plate 46, with FIG. 17d enlarged view of the corner from the lower surface 252 and FIG. 17e an enlarged view of the corner 256 on the upper surface 250. FIG. 17d with corner 256 and part of the lower surface 252 from above particularly illustrates slightly conical, projections 262. FIG. 17e illustrates part of the upper surface 250 and a rectangular stepped configuration being 264, 266 and slightly conical projection 268. Lower conical 262 projection and upper conical projection 266 are axially in line, the purpose of which will become more evident herein.

Although grill plate 46 as illustrated in the figures is cast aluminum, the invention contemplates grill plates of stainless steel of welded rods with appropriate projections to accommodate the skewer and the storing of the other elements with the grill plate to be further set forth herein.

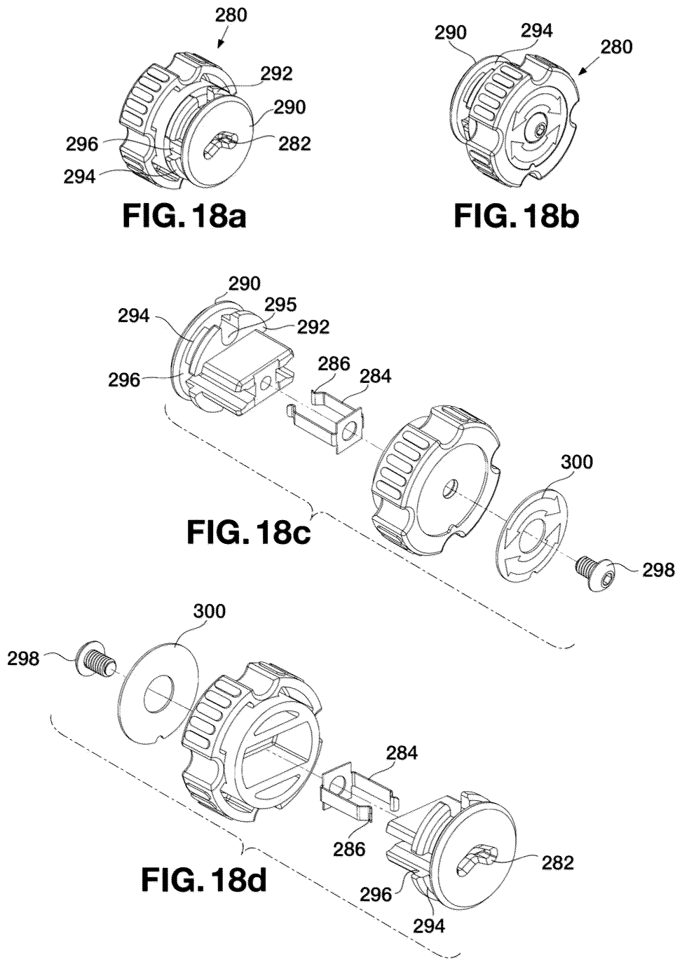

FIGS. 18a and 18b illustrate the inside and outside of a skewer knob 280 with central skewer aperture recess 282 in FIG. 18a. FIGS. 18c and 18d illustrate the construction of the knob 280 with spring armed portion 284 adapted and configured with spring dent ends 286 to allow the knob to be detachably connected with notches at the end of a skewer. Circular inner flange 290 is also noted and between flange 290 and circular flange 292 is groove 294. Inner flange 292 has 4 indents 296 peripherally spaced for connection with projection 78 in notches 76 (see FIGS. 5 and 13). Screw 298 fastens face plate 300 and secures knob 280 parts together.

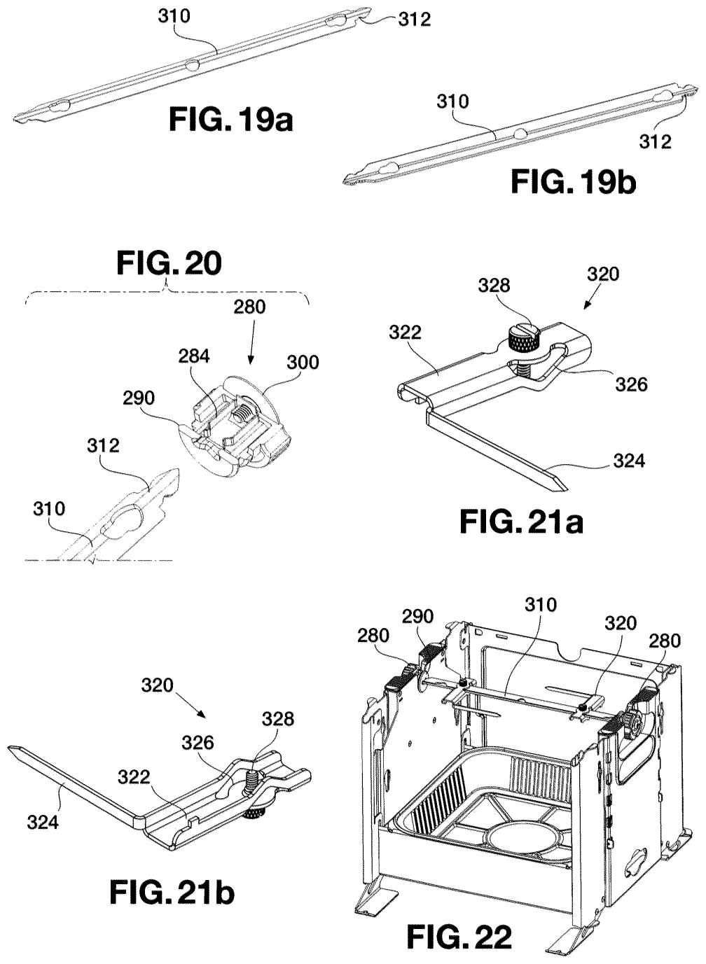

FIGS. 19a and 19b and FIG. 20 illustrate the skewer 310 and the detachable connection between the skewer handle 280 and skewer 310. Skewer 310 has end notches 312. The spring clip 284 detents 286 is fastened inside handle 280, and, as seen in FIG. 20, the detents 286 will cooperate with notches 312 of the skewer 310. The handle 280 and skewer 310 are in a push-pull connection. The skewer with button 280 may be selectively rotated at 90° intervals because the connection of projection 78 and button indents 296.

FIGS. 21a and 21b illustrate skewer clamps 320 with U-shaped part 322, and perpendicular to part 322 is tine 324. U-shaped part 322 has a triangular skewer opening 326 and threaded screw 328 cooperates with a threaded aperture to secure the clamps 320 to the skewer 310. There are two skewer clamps, the mirror image of each other as seen in FIG. 22 which illustrates the skewer 310 and tines 324 in an operative position held in place by knobs 280. Flange 290 of knob 280 cooperates with the U-shaped notch 76 to hold the knob in place with the projection 78 in operative association with a slot 296 of the knob 280.

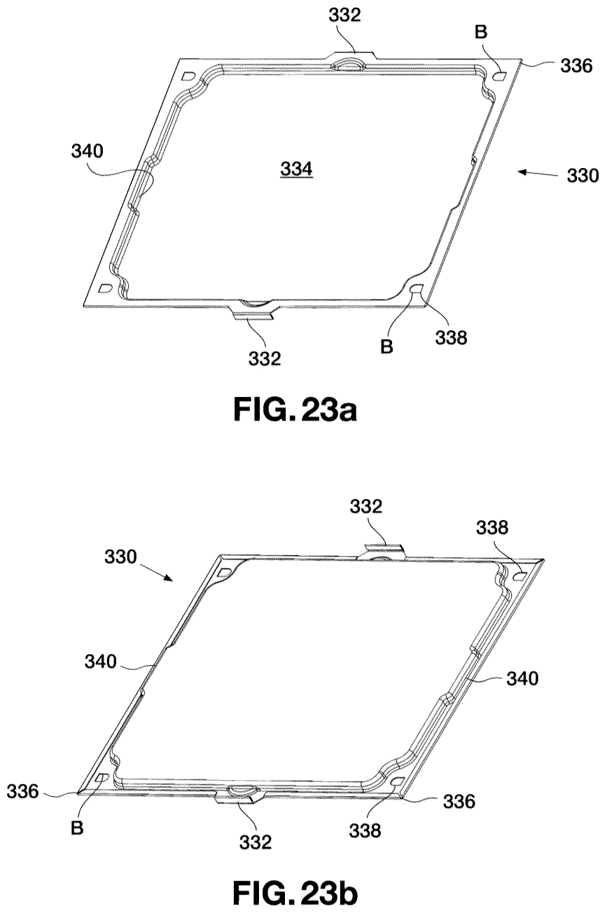

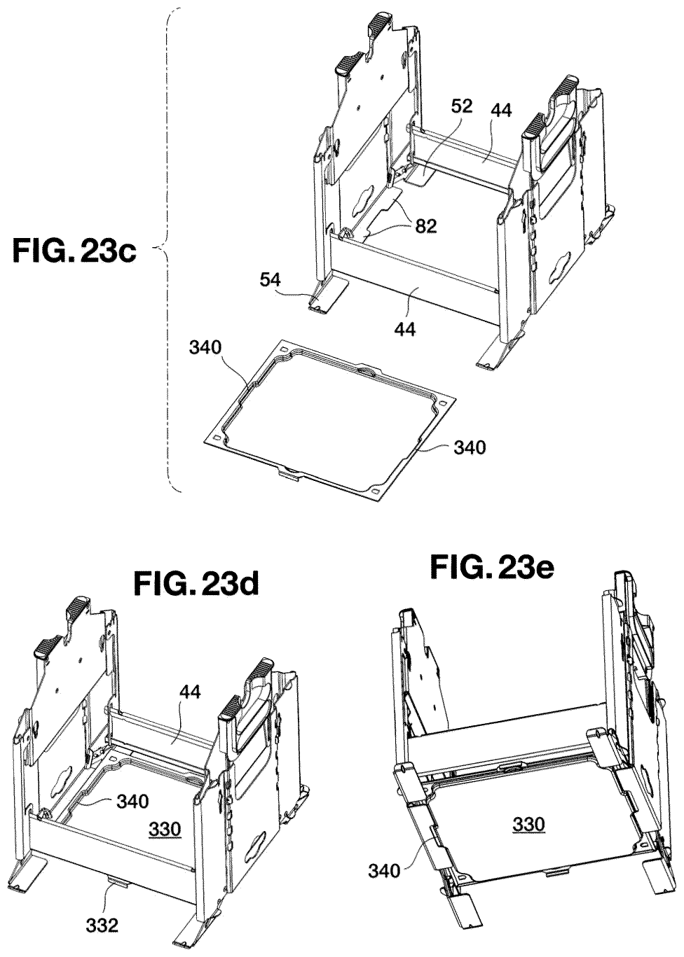

FIGS. 23a and 23b illustrate drip tray 330 for the grill, FIG. 23a is a top view and FIG. 23b a bottom view. On opposite sides are downwardly directed flanges 332 to permit insertion and withdrawal of the drip tray 330 into the grill. The drip tray 330 is formed with a depression 334 with the periphery of the depression configured to provide apertured corners 336 with apertures 338. Outwardly directed portions 340 on opposite sides 342 intermediate corners 336 are for locating the drip tray in the grill.

FIG. 23c illustrates the alignment of the drip tray for insertion into the grill bottom, under the cross braces 44 and above the feet 52 and 54. The flanges 82 with indentation therebetween, (FIG. 15) are configured to support the drip tray 330 and locate it with the outwardly directed floor portion 340 within the flange indentation between flanges 82.

FIGS. 23d and 23e illustrate the inserted drip tray from above and from underneath the grill.

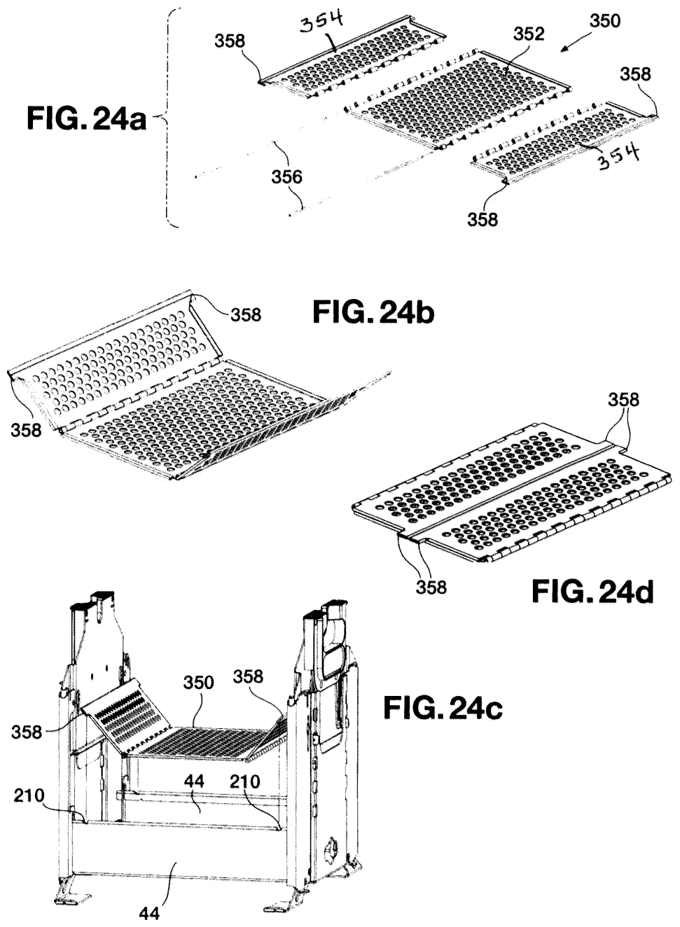

FIGS. 24a, 24b, and 24c illustrate an alternate support 350 for fuel in the grill assembly. FIG. 24a illustrates central sections 352, side sections 354 and rods 356 for connecting the sides to the central section. The sides 354 have outwardly directed corner projection 358. FIG. 24b illustrates the connected sections in an open position, with FIG. 24d illustrating the sections folded. FIG. 24c illustrates the assembly of fuel support 350 to the grill with projections 358 configured to connect with notches 210 on the cross braces 44 (FIG. 14).

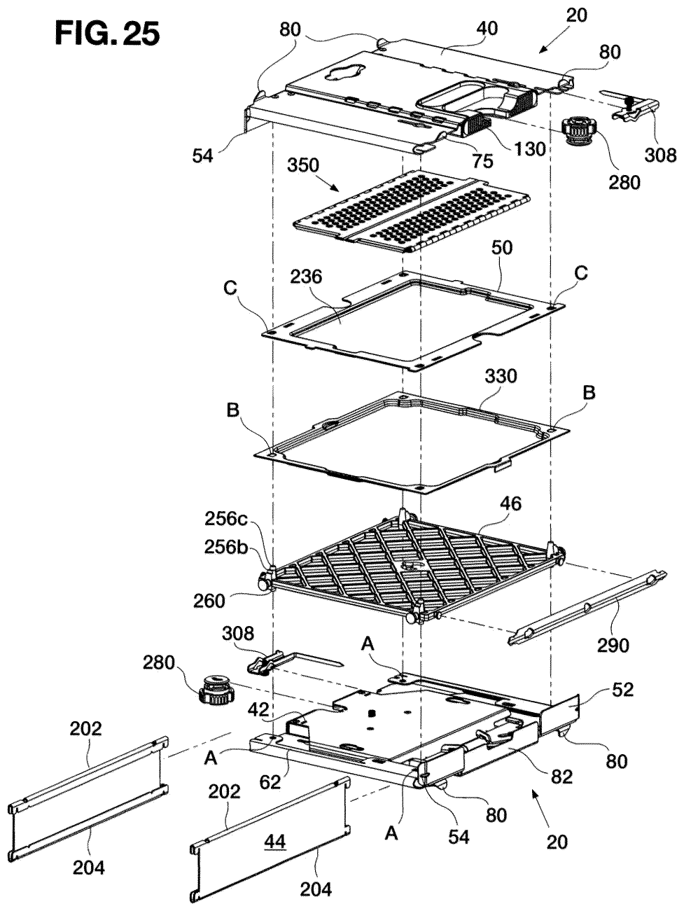

FIG. 25 indicates components of the grill in an exploded configuration, illustrating the side wall assemblies 20, one at the bottom, and one at the top at a 180° rotation from each other. There is also cross braces 44, the grill plate 46 and the rear wall 50. Also shown is the bottom drip tray 330, a folded fuel support 350 which provides an alternate to the fuel tray 56 of FIG. 1, a skewer 310, skewer spits 320 and knobs 280 for the ends of the skewer 310. FIG. 25 illustrates how the components are assembled with certain apertures, aperture C in the rear wall 50, aperture B in the drip tray 330, and aperture A in the outer side panels 40.

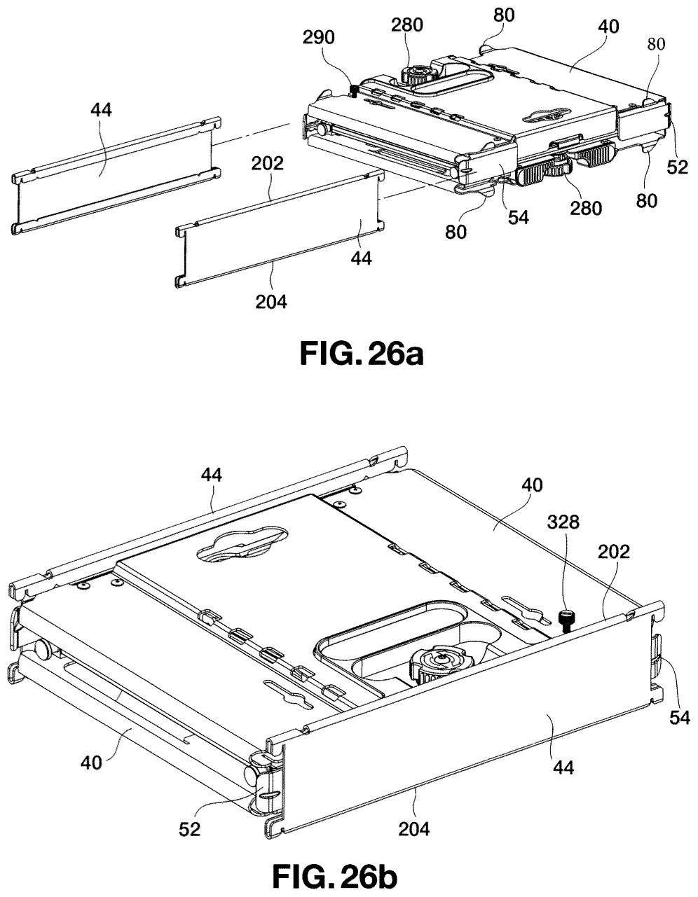

FIG. 26a illustrates the cross braces 44 being the rail flanges 202 and 204 slid into connection with flanges 80 of the outer side panel 40. Knobs 280 are located in U-shaped notches 68 and the skewer spits are screw tightened into slots 329 (FIG. 27a and FIGS. 16d and 15b).

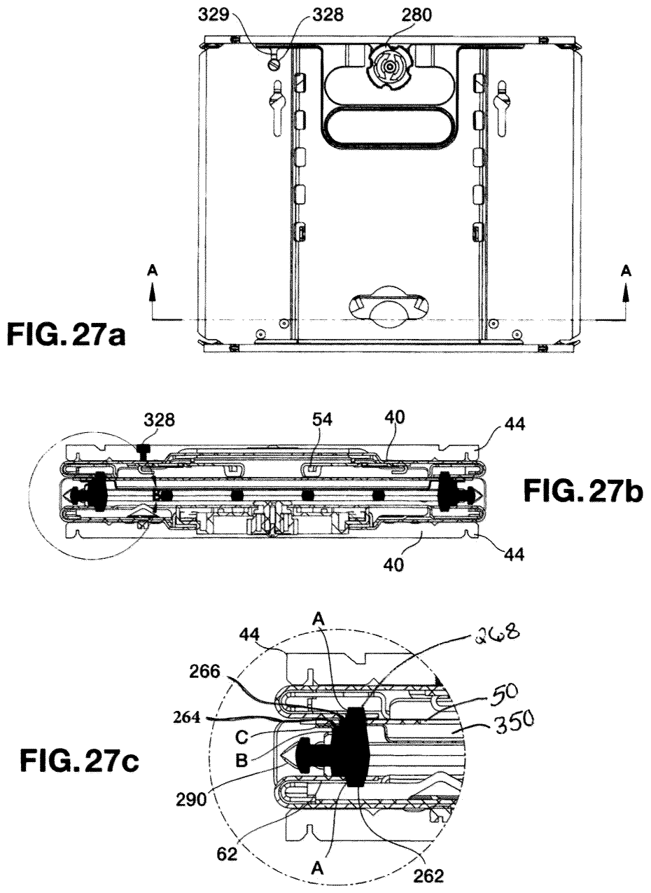

FIG. 27a illustrates a top view of the grill package with FIG. 27b being a sectional view and FIG. 27c an enlarged sectional view of circled part of the assembly of FIG. 27b. Grill plate 46 and its configured corner is shown in connection with the various apertures in the side assemblies, the rear wall and bottom drip tray.

From FIGS. 25 and 27, the folded fuel support 350 is configured to fit within the depression 236 of the rear wall 50.

In FIG. 25, the lower side wall assembly 20 showing circular apertures A on the lower flange 62 of the side panel 40. Apertures A are also shown in FIG. 9b and FIG. 15b.

Also as seen in FIG. 25 are D shaped apertures B on the drip pan 350, these apertures are also shown in FIGS. 23a and 23b.

Further, FIG. 25 shows smaller D shaped apertures C in rear wall 50, which apertures are also shown in FIGS. 16a-16e.

FIG. 27c illustrates the cooperation of apertures A with conical projections 262 of the grill plate 46 on the lower side assembly of FIG. 25 and upper conical projections 266 of grill plate 46 on the upper side assembly of FIG. 25. Larger D shaped apertures B of drip tray 350 rest on lower step 264 of the grill plate 46 and smaller D shaped apertures of rear wall 50 rests on upper step 266 of the grill plate corner.

With the grill packaged as shown in FIGS. 26 and 27, the grill may be easily placed into a knapsack or the like.

### Materials

With respect to the various parts of the BBQ, some materials are considered preferable for enhancing the weight of the parts in a knapsack type of package. The upper side panel handles 130 and skewer knobs 280 are of Peek (plastic) materials. The plastics would preferably be shot in their desired colors red and black (versus post-moldpainting) https://dielectricmfg.com/knowledge-base/peek/

The upper and lower side panels and cross braces are preferably Aluminum 5052-H32. This alloy has the formability desired as it does not crack along the bend lines.

The construction of the plastics and metal parts are designed to minimize any conduction paths from the metal. (using air gaps and bosses). Testing thus far has shown that the co-efficient of thermal expansion (CET) differences between the PEEK and the aluminum has not caused problems to date. The design is intended to freely allow the expansion and contractions to occur with minimal effect on either material.

The spring armed portions 284 of the knobs 280 and the slider 118 and clips 110 are stainless steel 304 for spring force and corrosion resistance.

The rivets and spacers are preferably aluminum.

### Accessories

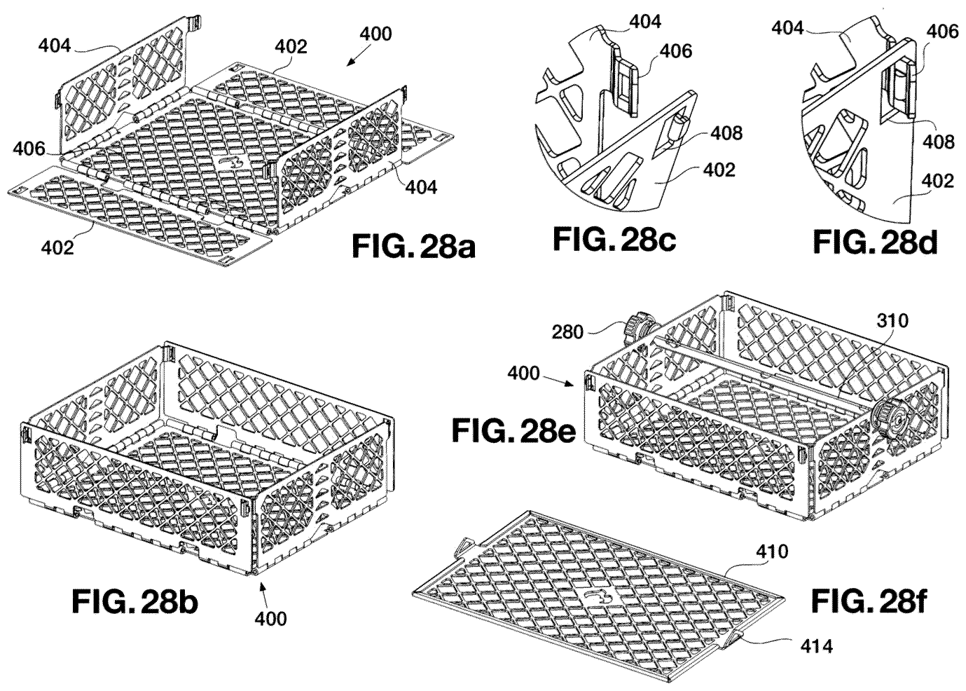

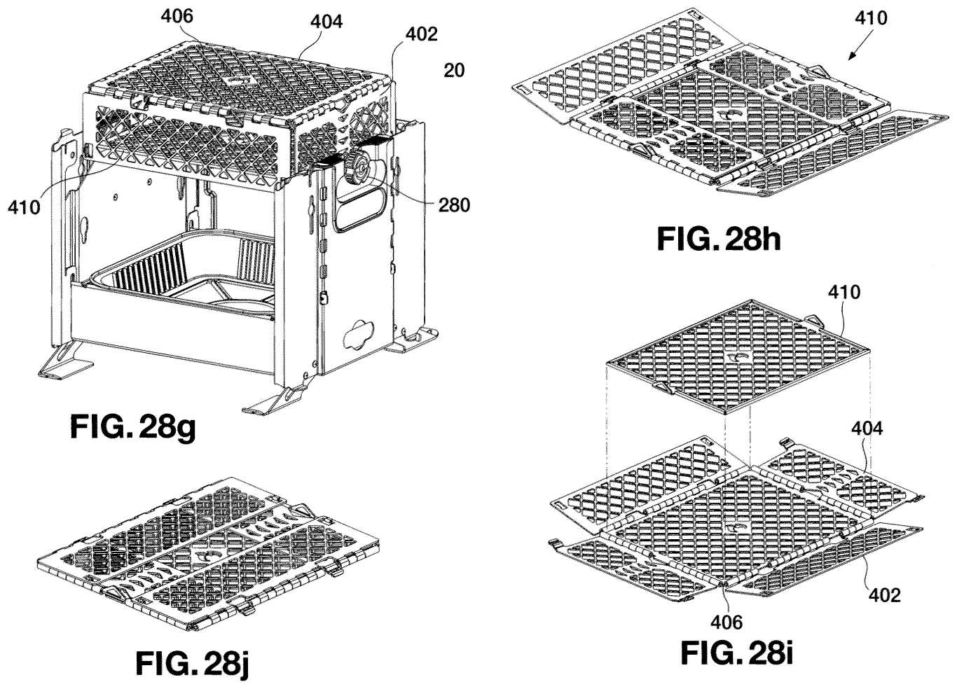

Accessory elements are illustrated in the FIGS. 28-32b, many of which have been illustrated and described in the previously noted applications and are accordingly not detailed as in the previous applications.

FIG. 28a and FIG. 28b illustrate a basket 400 for the grill composed of sides 402 and ends 404 with hinges pivoting on rods connecting to base 406.

FIGS. 28c and 28d are enlarged views of a corner of the basket illustrating the attachment of an apertured projection 406 on an end 404 which snaps into an aperture 408 of the side 402.

FIG. 28e illustrates the basket with a skewer 310 for support on the grill and FIG. 28f illustrates a cover 410 if the food to be cooked should be rotated. As further illustrated in FIG. 28g, the cover 410 is at the bottom of the basket on the skewer 310 and is connected with the basket through skewer 310 and cover apertures 414 and apertures 416 in the basket ends 404. FIGS. 28h, 28i, and 28j illustrate the collapsing of the basket where the cover 410 fits within the hinges of the basket.

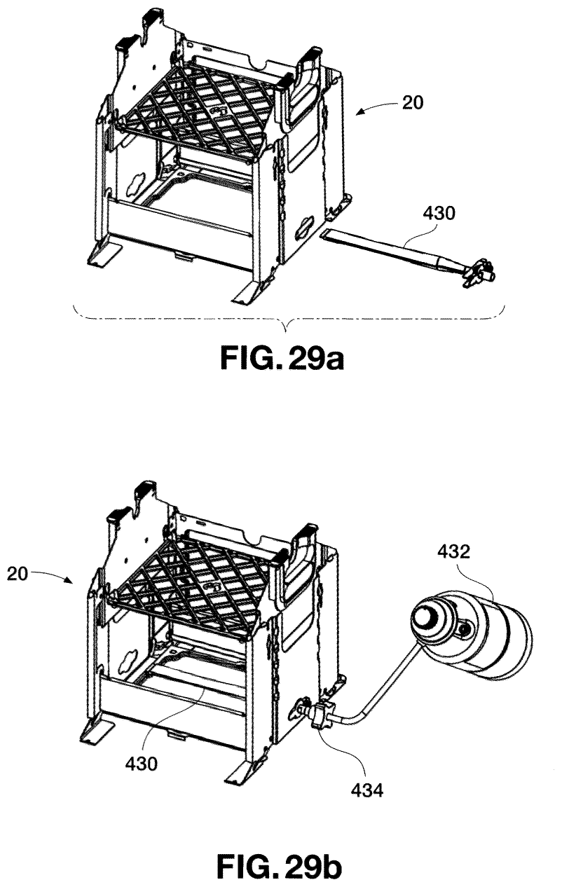

FIGS. 29a and 29b illustrate the accessory of a gas burner 430, gas cannister 432 and regulator 434. The connection is the same as set out in the previous applications.

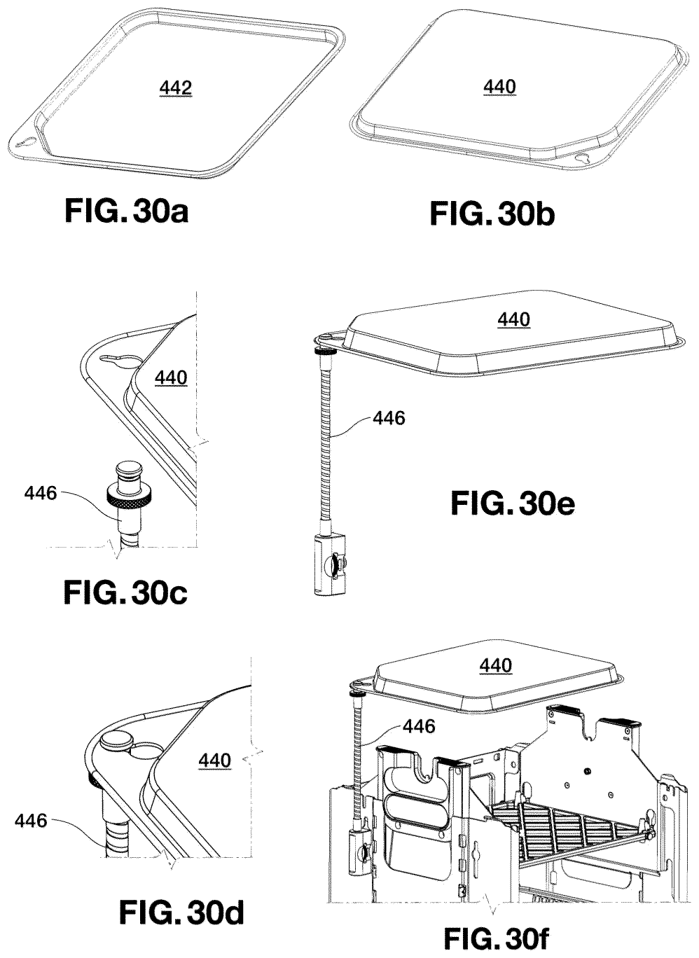

FIGS. 30a and 30b illustrate the upper side 440 of a rain shield and the lower side 442. FIGS. 30c, 30d, 30e and 30f illustrate, similarly as in the earlier applications, the assembly and connection of the shield to pole 446 and to the grill assembly.

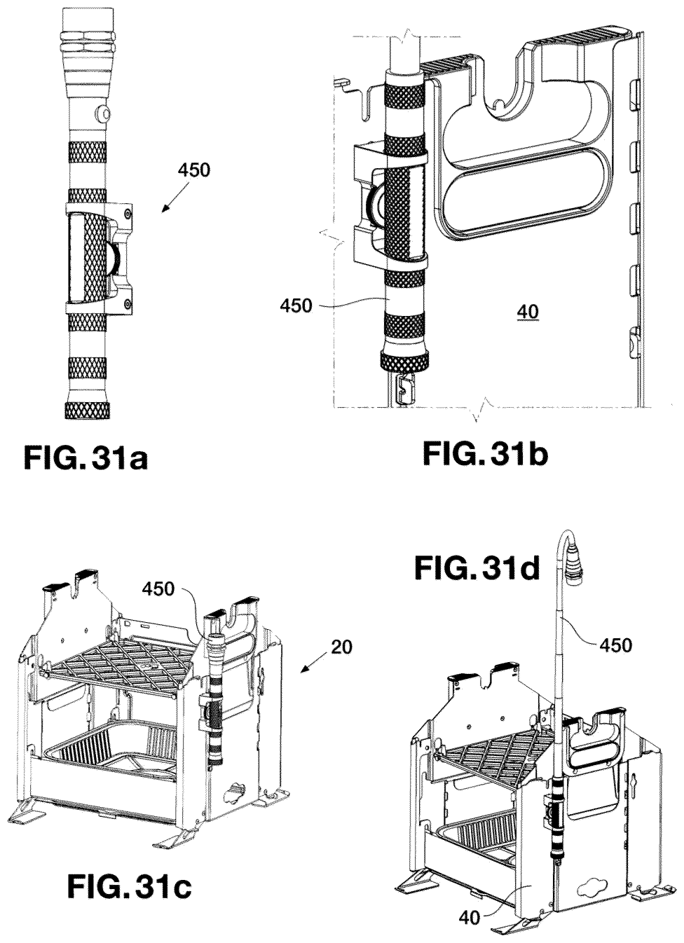

FIG. 31a illustrates a flashlight 450 with FIGS. 31b, 31c, and 31d illustrating the connections to the grill assembly in the same manner as set forth in the earlier applications. FIG. 31c illustrates the flashlight in a non-extended position, whereas FIG. 31d illustrates the flash light in the extended position.

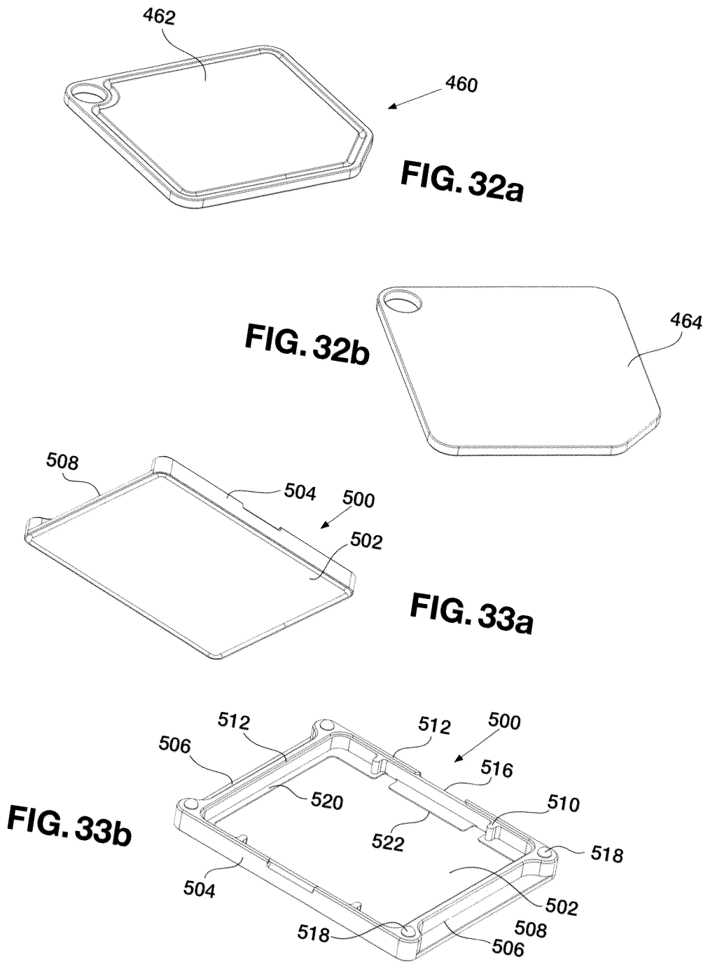

FIGS. 32a and 32b illustrate a cutting board 460, the top 462 and bottom 464.

FIGS. 33a and 33b illustrate a modified cutting board 500 have surface 502 with sides 504 and ends 506. Each end has a recess 508. Projections 510 extend inwardly from sides 504 and lip 512 extends peripherally except at breaks 516 on sides 504. Dome buttons 518 are located at each corner and internal raised section 520 and 522 are shown.

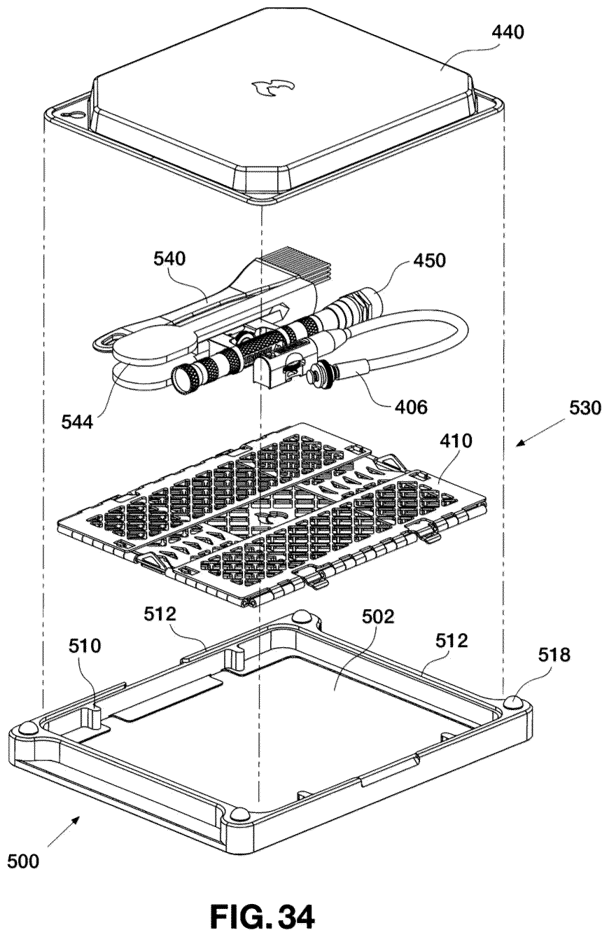

FIG. 34 is an exploded perspective view of the assembly of accessory kit 530 which includes shield 440 (see FIGS. 30a and 30b), folded basket 410 (see FIG. 28j), shield support 446 (see FIG. 30e), and flashlight 450 (see FIG. 31a). In addition, there is a whisk 540 and tongs 544. Folded basket 410 is configured to fit inside cutting board 500 resting on raised sections 520, 522 and within projection 510 accessories, pole 446, flashlight 450, whisk 540, and tongs 544 sit on top of folded basket 410. Shield 440 is assembled to sit on projections 510 and lip 512.

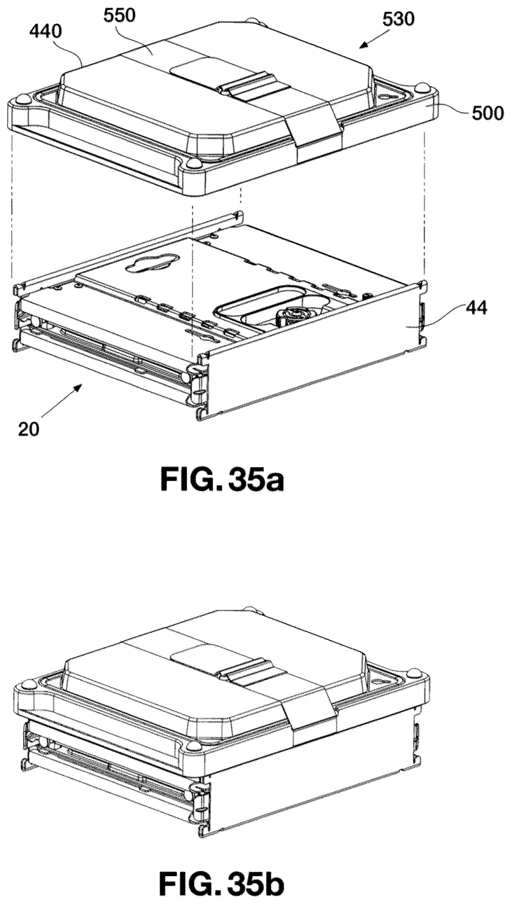

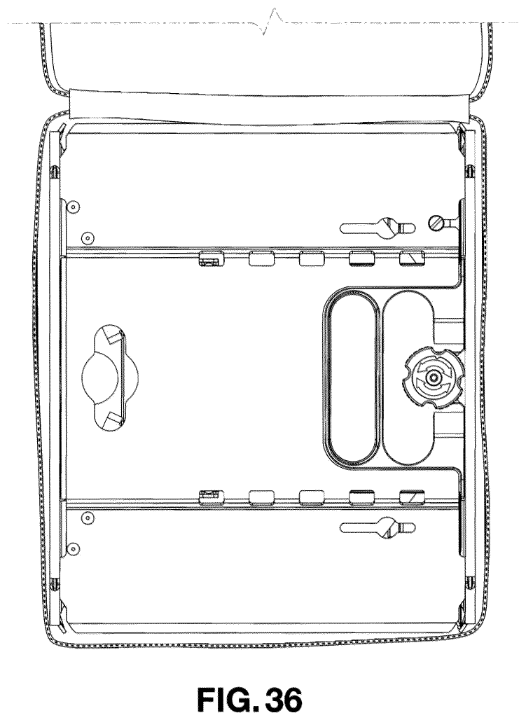

The assembled accessory kit 530 in FIGS. 35a and 35b has strap 550 to maintain the kit 530 as a unit which then sits on the assembled grill (see FIG. 26b) and suitable for packing as the two units in a knapsack or the like as illustrated in FIG. 36 (only the grill assembly shown).

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims.

What is claimed is:

1. A portable BBQ grill assembly comprising:
two mirror imaged side panel assemblies, said side panel assemblies each comprising a lower side panel and an upper side panel, each lower side panel having at least one outwardly directed flange at the base of the lower side panel;
two cross braces configured in operative position to connect with sides of the lower side panels and space the lower side panels apart;
each upper side panel, is configured to slideably connect with one of the lower side panels; a grill plate configured to detachably connect with the slideable upper side panels; and wherein, when the grill is in packaged condition, said side panel assemblies house at least the grill plate between them and the cross braces slideably connect with the at least one outwardly directed flange of both of the lower side panels.

2. The grill assembly of claim 1 further comprising a rear wall and a drip tray, the rear wall configured to detachably connect between sides of the lower side panels and the drip tray configured to detachably connect with the spaced lower side panels below the cross braces, the rear wall and drip tray also configured to be located with the grill plate between both of the lower side panels when the grill assembly is in the packaged condition.

3. The grill assembly of claim 2 further comprising a fuel support configured to be suspended from the cross braces when the grill is in the operative position and also configured to nest within the drip tray when the grill assembly is in the packaged condition.

4. The grill assembly of claim 3 wherein the grill plate has corners, with each corner having projections perpendicular to a plane of the grill plate, one of the projections being a downwardly directed projection adapted for connection with a circular aperture of one of the lower side panels, an upwardly directed projection in axial alignment with the downwardly directed projection and adapted for connection with the other lower side panel, and stepped projections adjacent the upwardly directed projections; and wherein each corner of the rear wall and each corner of the drip tray has an aperture for connection with one of the steps of the stepped projections.

5. The grill assembly of claim 1 further including feet structure, including feet slidably connected with the lower portion of the outer side panel, the structure and feet adapted to slide downwardly and outwardly from a retracted position to an extended position; and wherein the feet structure comprises a bracket wherein the extended position prevents the cross braces from being removed from the outer side panels.

6. A combination of the grill assembly of claim 1 and an accessory package, the accessory package comprising a breadboard and a rain shield, the breadboard having an outer flat surface with downwardly extending walls, the rain shield and the breadboard, when inverted, configured to locate the rain shield on top of the inserted breadboard to define a space for housing accessories to the grill assembly, including a grill basket, rain shield support, and flashlight, the accessory package having a strap to maintain the rain shield and inverted breadboard together, the accessory package configured and adapted to sit on the grill assembly for inserting the combination into a carrying case.
